(19) United States
(12) Patent Application Publication
(10) Pub. No.: US 2024/0055873 A1
(43) Pub. Date: Feb. 15, 2024

(54) Energy Storing Cable with Hybrid Energy Storage Management System

(71) Applicants: Joseph Sleppy, Maitland, FL (US); Alisa Silverstein, Orlando, FL (US); Isaac Finley, Jaclsonville, FL (US)

(72) Inventors: Joseph Sleppy, Maitland, FL (US); Alisa Silverstein, Orlando, FL (US); Isaac Finley, Jaclsonville, FL (US)

(21) Appl. No.: 18/231,375

(22) Filed: Aug. 8, 2023

Related U.S. Application Data
(60) Provisional application No. 63/398,200, filed on Aug. 15, 2022.

(51) Int. Cl. H02J 7/00; H01B 7/00

(52) U.S. Cl. CPC H02J 7/0014; H01B 7/00; H02J 7/345

(57) ABSTRACT

A flexible energy storing cable contains a plurality of individual supercapacitors and their respective balancing circuits, along with a single control circuit to manage all of the individual balancing circuits through a data link, which may be wired within the cable or may be wireless. The cable is preferably flexible enough to bend around a radius of about five times its diameter or less. The system may contain further modules such an AC/DC converter, DC/DC converter, DC/AC converter, source control, etc., which may be external to the cable or integrated within the cable if size permits. A supercapacitor management system and/or a hybrid energy storage isolation system may be integrated in-line into the energy storing cable.

### CROSS REFERENCE TO RELATED APPLICATION

This application claims the benefit of U.S. Prov. Pat. Appl. No. 63/398,200, entitled, “Energy Storing Cable with Hybrid Energy Storage Management System” and filed by Applicant on Aug. 15, 2022, the entire disclosure of which is incorporated herein by reference.

### BACKGROUND OF THE INVENTION

### Field of the Invention

The invention pertains to energy storage technologies, and more particularly to energy storage in a flexible cable containing supercapacitors and power management electronics.

### Description of Related Art

A supercapacitor, also known as an ultracapacitor, is an energy storage device that has a high power density and low energy density, meaning it is able to accept and deliver charge very quickly but cannot provide the energy for a long period of time. Supercapacitors also feature a long cycle life (e.g., up to 1 million cycles when operating at room temperature).

Supercapacitors are typically manufactured in a rigid, radial form that is intended to be mounted to a printed circuit board (PCB) and soldered onto the board via the terminals that are protruding from the supercapacitor.

A battery, such as lithium-ion, lithium-polymer, lithium-iron-phosphate, nickel-metal hydride to name a few, is an energy storage device that has a high energy density and low power density, meaning it can store and deliver energy over a long period of time but cannot supply energy in quick bursts. Surges in energy draw can place stress on the battery, in turn decreasing its capacity and shortening its operating life.

Supercapacitor management systems (SMS) monitor aspects of a supercapacitor bank and ensure that the individual cells stay balanced, meaning the voltages of the individual supercapacitors in the system are similar and below their maximum voltage rating. There are different approaches to balancing supercapacitors, which can be broadly classified as either passive or active.

Passive balancing typically consists of using voltage divider circuits or some resistance in parallel with the supercapacitor, often through a switch, which is closed when the supercapacitor is detected to be over voltage so the energy is consumed by the resistor. While this method is generally simple and low-cost, the balancing process can be slow and inefficient.

Active balancing typically consists of removing charge from the supercapacitors at a higher voltage and distributing it to the supercapacitors at a lower voltage. This can be accomplished using integrated circuits, capacitors, inductors, or DC/DC converters. While this method is highly efficient, designs are typically limited to low power applications and are relatively high cost since it requires several additional energy storage components.

A battery-supercapacitor hybrid energy storage system (BS-HESS) is a system that combines batteries and supercapacitors into one energy storage system that features the desirable characteristics of batteries (high energy density) and supercapacitors (high power density). In order to take advantage of these combined characteristics and extend the system life span, it is necessary to maintain a safe delivery of energy. Based on currently available literature, management systems are categorized as being passive, semi-active, or fully active.

Passive BS-HESS are the simplest and most inexpensive topology, as the battery and supercapacitor are connected directly in parallel. However, since they share the same terminal voltage, the full range of the supercapacitor's state of charge (SoC) will not be utilized and as a result, is an inefficient use of a supercapacitor. The current delivered by the supercapacitor is also limited to the speed that the voltage across the battery drops, restricting the level of power provided by the supercapacitor below its full capability.

The semi-active HESS topology introduces power electronic converters between the elements. This allows the flow of power for one of the two elements to be actively controlled. Typically, this would include a DC/DC converter between either the supercapacitor and the DC bus or the battery and the DC bus. In instances where the power flow from the supercapacitor is controlled by the DC/DC converter, the supercapacitor can be operated within a wider voltage range, improving the efficiency compared to the passive BS-HESS. However, the battery can still be exposed to fluctuating high current due to its passive connection to the DC bus. In instances where the power flow from the battery is controlled by the DC/DC converter, the battery is protected from fluctuations in power demand. However, the supercapacitor will not be operating within its full voltage window, resulting in a low volumetric efficiency.

In the fully active HESS topology, the power flow from both the battery and supercapacitor are actively controlled via a DC/DC converter. The two most common methods used in the active HESS method are parallel active and cascaded active. In the parallel active configuration, both the battery and the supercapacitor are isolated from the DC bus through a DC/DC converter. In the cascaded active configuration, one DC/DC converter is placed in parallel between the battery and supercapacitor, and the second converter is placed in parallel between the supercapacitor and the DC bus.

US 2018/0027207A1 to Brian Jeffrey Wengreen, describes electrically coupling an electronic circuit to a cable used for a streaming media player. The electronic circuit can include a supercapacitor to store a portion of the power from the USB power source and release the stored power when power demanded by the streaming media player is less than the available power from the USB source.

The previously mentioned approach of coupling an electronic circuit which can include a supercapacitor with a cable limits the flexibility of said cable and creates a bulky exterior. What is needed, therefore, is a method to incorporate supercapacitors into a cable with little to no footprint.

U.S. Pat. No. 9,627,908B2 to Ilya Kaminsky et al., describes a two-terminal battery-supercapacitor parallel configuration that switches to selectively control power flow to its respective terminal. Connecting a battery, capacitor, and rectifier can allow unidirectional current flow to decrease current draw from the battery when the capacitor powers external subjects. Embodiments of the two-terminal battery-supercapacitor module can be set as “drop-in” replacements in a vehicular battery system. This approach forces design tradeoffs as space is poorly utilized; the space where batteries would be is consumed by supercapacitors, reducing the total amount of energy stored in the system.

U.S. Pat. No. 9,496,799B2 to Stefan M. Goetz et al., describes an electrical converter that uses switching elements such that the capacitors can be connected in series or in parallel so that the corresponding losses are minimized.

U.S. Pat. No. 7,667,438B2 to Cyrus N. Ashtiani et al., describes an energy storage system for a hybrid electric vehicle where a battery with a diode in series is electrically coupled in parallel with a supercapacitor. The diode isolates the battery from the load as long as the supercapacitor voltage exceeds the battery voltage.

U.S. Ser. No. 10/418,825B2 to Ka Wai Eric Cheng et al. describes a voltage balancing circuit for power storage devices, where a power storage device comprises at least one type of rechargeable battery and supercapacitor. The circuit comprises of switches (single-pole double-throw) connecting the first terminals of the storage devices, while the second terminals of the power storage devices are connected to a common neutral line.

All of these prior approaches describe systems to couple supercapacitors to each other and/or to batteries. In U.S. Pat. No. 7,667,438B2, while the battery is protected from current surges while the supercapacitor voltage is larger than the battery voltage, the full capacity of the supercapacitor is never utilized. U.S. Ser. No. 10/418,825B2, while an effective method to balance supercapacitors, may require a large PCB dependent on the number of supercapacitors in the system.

What is needed, therefore, is an improved method to integrate both supercapacitors and power management circuitry into a cable form factor to better utilize space, enable the usage of supercapacitors into a system with fewer design tradeoffs, and form an all-in-one drop in solution that forms battery-supercapacitor hybrid energy storage systems with existing battery-only energy storage systems.

Objects of the present invention include the following: providing a string of supercapacitors or other energy storing devices in series and/or parallel enclosed within a flexible, sealed cable; providing a supercapacitor management system to balance the supercapacitors' voltages; and providing a hybrid energy storage management system to isolate the supercapacitor cable and load from the source. These and other objects and advantages of the invention will become apparent from consideration of the following specification, read in conjunction with the drawings.

### SUMMARY OF THE INVENTION

According to one aspect of the invention, an energy storing cable comprises:
a flexible elongated sheath;
an input connection;
an output connection;
a microcontroller; and,
a plurality of individual energy storage modules contained within the sheath, each module comprising at least one capacitor(s) and at least one switching device operatively connected to the capacitor(s) and to the microcontroller so that the microcontroller may balance the charge states of each of the individual energy storing modules and manage the flow of power between the source, energy storage modules, and load;
   wherein the individual energy storing modules are sufficiently spaced apart from one another along the length of the sheath so that the energy storing cable has a useful degree of flexibility.

### BRIEF DESCRIPTION OF THE DRAWINGS

The drawings accompanying and forming part of this specification are included to depict certain aspects of the invention. A clearer conception of the inventions, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 shows one arrangement of components used to provide energy storage using a battery and capacitors in accordance with the PRIOR ART.

FIG. 2 schematically illustrates an energy storing cable in accordance with some aspects of the present invention.

FIG. 3 schematically illustrates another energy storing cable in accordance with some aspects of the present invention.

FIG. 4 schematically illustrates another energy storing cable in accordance with some aspects of the present invention.

FIG. 5 schematically illustrates another energy storing cable in accordance with some aspects of the present invention.

FIG. 6 schematically illustrates another energy storing cable in accordance with some aspects of the present invention.

FIG. 7 schematically illustrates another energy storing cable in accordance with some aspects of the present invention.

FIG. 8 schematically illustrates another energy storing cable in accordance with some aspects of the present invention.

FIG. 9 shows a basic level of logic for the supercapacitor balancing system.

FIG. 10 shows a basic level of logic for the hybrid energy storage isolation system.

FIG. 11 shows a circuit diagram for the supercapacitor balancing system paired with the hybrid energy storage isolation system. An associated microcontroller is not shown.

FIG. 12 shows a supercapacitor balancing system for a system that includes 2 supercapacitors in parallel and 2 supercapacitors in series.

FIG. 13 shows the wiring schematic for the hybrid energy storage isolation system. This example pairs one battery with one supercapacitor.

FIG. 14 shows one example with the switches in-line with the supercapacitors.

FIG. 15 shows one example of the system architecture for a cable containing four supercapacitors.

FIG. 16 shows one example of an individual balancing circuit for one capacitor.

FIG. 17 shows one example of a balancing circuit for one capacitor and a control circuit for that capacitor and three others. The two circuits may be co-located on a single circuit board.

FIG. 18 schematically illustrates another energy storing cable in accordance with some aspects of the present invention.

### DETAILED DESCRIPTION OF THE INVENTION

The invention generally involves making an automatically managed, drop-in energy-storage device with the form of a generally flexible cable, instead of a supercapacitor bank arrayed on a rigid circuit board, in a rigid enclosure or as part of a cabinet, as is typical of the traditional approach. It will be shown that the invention preferably uses a very different circuit architecture in order to distribute the capacitors spatially and balance them electrically. The unique architecture and form factor offer numerous benefits to end users who will incorporate the inventive devices into electronic equipment and systems. Such systems may range from individual devices to grid-scale power applications

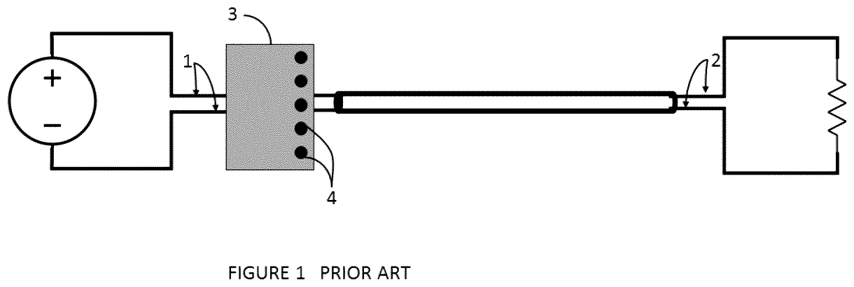

It is well known in the art that many situations arise in which a battery is used to power a fluctuating load. In such cases, the load may momentarily demand a large draw of power, which can have several deleterious effects, including a drop in the voltage, potentially below what is expected at the load, and possible damage to the battery itself. Conventionally, systems are configured with a bank of supercapacitors 4 (e.g., AVX SCM Series, ranging from 0.47 to 7 F) disposed standing side-by-side on a rigid circuit board 3 as shown generally in FIG. 1. The battery acts as a source of input power 1 into the board 3, and a system of switches and a microcontroller or integrated circuit (e.g., Analog Devices LTC3625) on the rigid circuit board manages the charging and discharging of the capacitors so that sufficient output power 2 is supplied from the battery through the board to the load.

The conventional approach as illustrated in FIG. 1 has several shortcomings. First, the need to accommodate the rigid circuit board 3, which might typically be 10×10×5 cm for a small application (5.4 V, 0.04 Wh supercapacitor energy storage system comprising two 2.7 V, 10 F supercapacitors connected in series and balanced) and 30×by 22.5×11 cm for a large application (24 V, 2.2 Wh supercapacitor energy storage system comprising twelve parallel strands of seven 5.4 V, 7.5 F supercapacitors connected in series) and tends to consume valuable real estate on, e.g., a computer motherboard for a small application or an electric scooter for a large application. This can force design tradeoffs such as requiring larger circuit boards to accommodate the supercapacitor energy storage system or sacrificing features to make space to add the supercapacitors. Second, for some applications that connect multiple existing products together as a system, such as the case in rooftop photovoltaic systems, the approach of integrating supercapacitors on existing circuit boards is difficult and not ideal. For example, if an inverter or battery vendor were to include supercapacitors in their product offering, they would need to launch a new product line to address the various kinds and sizes of systems their customers use, would face the challenges described in our first point regarding space, and that new product line would be significantly larger than their existing products. As such, system integrators may consider a product where supercapacitor modules are installed in a single rigid enclosure and connected between the power source (solar panels and battery) and load (inverter). While adding supercapacitors in this way will improve performance, this approach adds another eyesore that end users do not desire. In e-mobility examples, there are significant space constraints. Adding a supercapacitor bank requires design tradeoffs such as removing batteries (which reduces vehicle range) or sacrificing cargo space to make room for supercapacitors. The challenge with the existing approach is finding the physical space to add supercapacitors in a single location. Finally, given their low voltage rating, the complexity of balancing supercapacitors increases as more cells are connected in series for higher voltage, higher power applications. In these applications, large numbers of supercapacitors are grouped together on a single circuit board and managed as a group. Managing a large number of supercapacitors in a single group is more difficult and complex than managing fewer supercapacitors (such as two cells connected in series at a time).

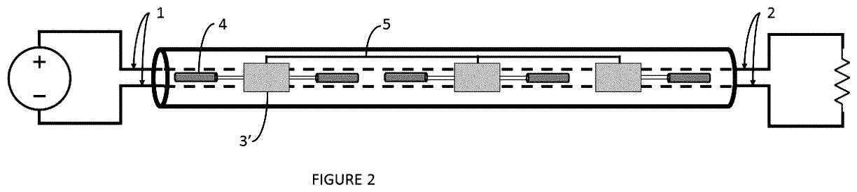

Some exemplary system-level architectures are shown generally in FIGS. 2-8, in which those skilled in the art will see that the invention provides a completely different architecture for a battery-supercapacitor hybrid energy storage system, eliminating the singular rigid circuit board and in its place creating a linear or chainlike array of individual modules, each module having one or more capacitors and one or more switches. The microcontroller function is preferably carried out by a plurality of individual microcontrollers or integrated circuits located along the chain; any particular microcontroller or integrated circuit may manage the switching of a single capacitor module or it may manage several capacitor modules. Applicants have found that the linear array illustrated in FIGS. 2-8 can be conveniently housed in a flexible protective insulating sheath, providing the end user with a completely new way of incorporating supercapacitors into a product or system to complement power sources (forming a hybrid energy storage system) without consuming valuable space where the power source or load is housed while avoiding design tradeoffs, avoiding additional complexity (by having power management pre-integrated in the cable), and avoiding eyesores by making use of existing wiring infrastructure.

The following examples describe some particular configurations in which an energy storing cable may be designed.

### Example

FIG. 2 illustrates a configuration in which supercapacitors 4 are balanced in groups (in this case pairs) using local balancing circuits 3′. In this case 3′ comprises a PC board with switches, programmable microcontrollers, active and passive components, analog-digital converters, and integrated circuits somewhat similar to what might be used in the PC board 3 in FIG. 1, except that balancing circuits 3′ are associated with particular capacitors 4 or groups of them, so that the entire system can be made into a flexible assembly. A communication or data line 5 is provided so that these distributed or modular units may work together as an integrated system. It will be appreciated that the data line 5 may comprise a hard-wired or wireless link; a wireless link may conform to any suitable protocol, such as Bluetooth, Zigbee, IEEE 802.11, and others as are well known in the art.

### Example

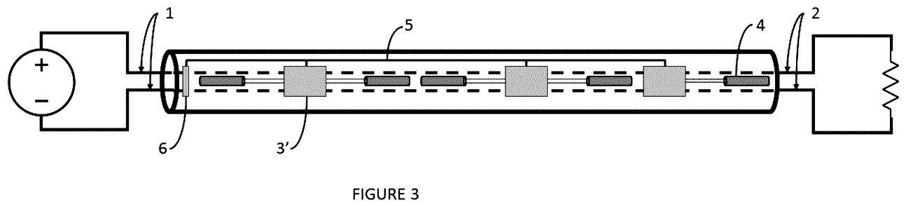

FIG. 3 illustrates schematically a system in which the capacitors 4 are balanced in groups by balancing circuits 3′, while a microcontroller 6 manages the balancing process for the entire cable using data line 5.

### Example

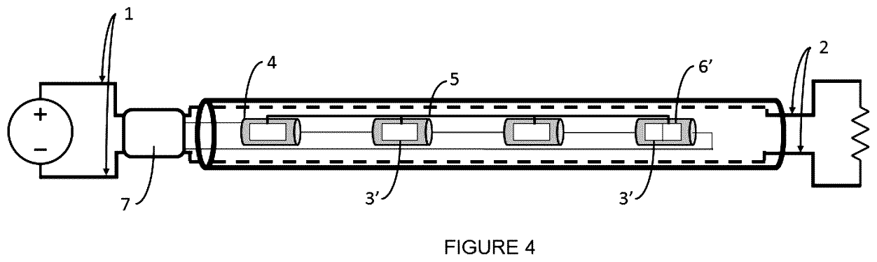

FIG. 4 illustrates schematically a system in which a DC/DC bidirectional converter 7 (e.g., Vicor BCM6123TD0G5030yzz) controls how much power comes into the cable from the source. Although converter 7 is shown as a separate component, it will be appreciated that it may be incorporated into the cable, depending on routine engineering considerations such as the overall power capability, size of the cable and other components, etc. The DC converter 7 may or may not be part of the design depending on application goals. Note that in this example, microcontroller 6′ is associated with the last capacitor in the cable. This controller may be a separate board or it may be co-located on a common board with the balancing circuit 3′ for that capacitor. Converter 7 may have multiple ports. The cable may connect to its own port or share a port with output 2.

### Example

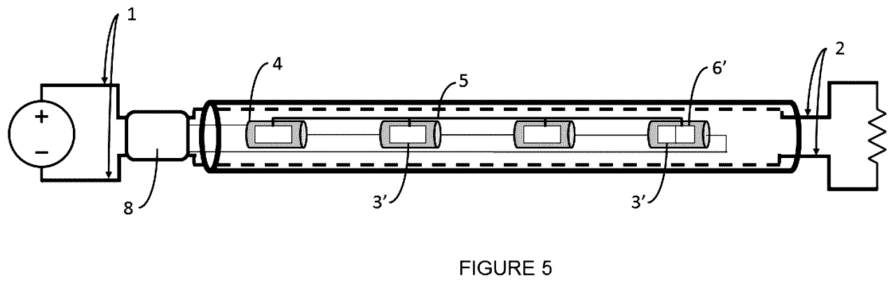

FIG. 5 illustrates schematically a system in which a source control circuit 8 (e.g., a circuit designed using Analog Devices MAXI 7701) controls how much power comes into the cable from the source. Source control circuit 8 may have multiple ports. The cable may connect to its own port or share a port with output 2.

### Example

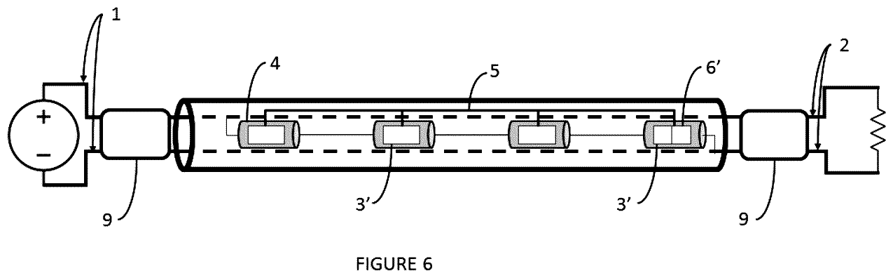

FIG. 6 illustrates schematically a system in which a DC/DC converter circuit 9 (e.g., Mean Well NSD05-12S12) controls what voltage comes into the cable from the source and a second DC/DC converter 9 controls what voltage exits the cable into the load. In some cases the first and second converter can be identical devices but may be tuned differently according to what the load requires. In other cases they may be different models of DC/DC converter.

The invention may also be used for cables from AC power sources, as described in the following examples. Depending on the application, the AC power input and/or output may be single, split, or three phase at various voltages including but not limited to: 120V, 240V, and 480V and at various frequencies such as 50 Hz or 60 Hz. The converter selected for use in the cable may also be bidirectional as needed.

### Example

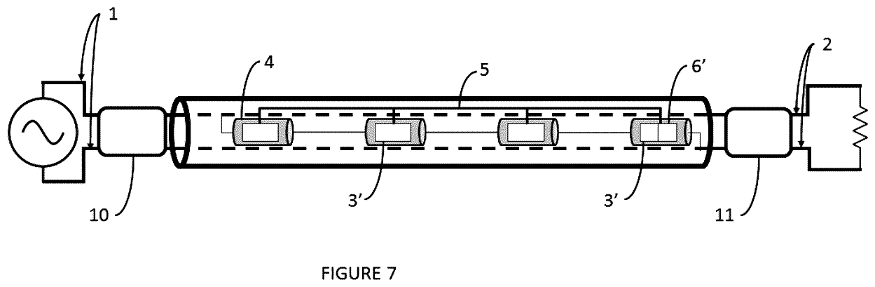

FIG. 7 illustrates schematically a system in which an AC/DC converter 10 (e.g., Mean Well UHP-750-12) controls what voltage comes into the cable from the source and a DC/AC converter 11 (e.g., Mean Well NTS-400P-112) controls how much power exits the cable to the load. The MAX17701 can be used with these converters to also control how much power is flowing from the source to the cable. It will be appreciated that components 10 and 11 may be external to the cable, as shown, or may be enclosed within the cable sheath if size permits.

### Example

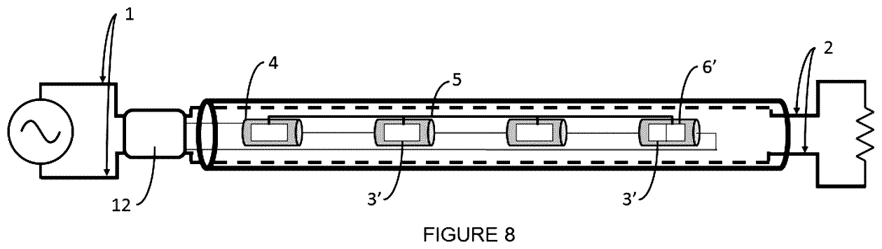

FIG. 8 illustrates schematically a system in which an AC/DC bidirectional converter 12 (e.g., Mean Well BIC-2200-12) controls what voltage comes into the cable from the source. Optionally, additional features can be added, such as using the MAX17701 to control power flow. It will be appreciated that converter 12 may be external to the cable, as shown, or may be enclosed within the cable sheath if size permits. Converter 12 may have multiple ports. The cable may connect to its own port or share a port with the output 2.

### Example

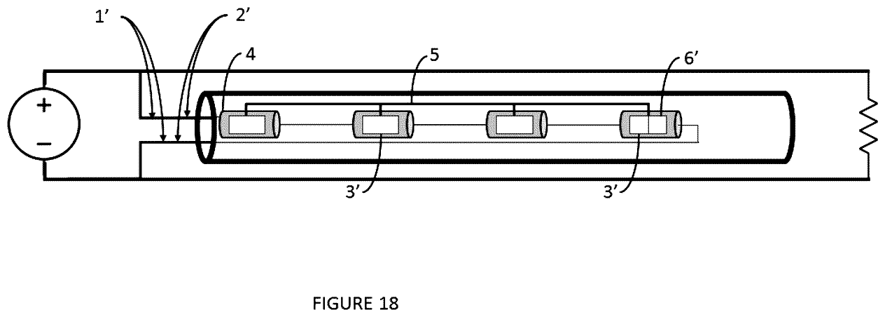

FIG. 18 illustrates schematically a system in which the capacitors 4 are balanced in groups by balancing circuits 3′, while a control circuit 6′ manages the balancing process for the entire cable using data line 5. It will be appreciated that the input wires 1′ and output wires 2′ are the same pair of cables and exit the cable sheath on the same end. One can see from the circuit diagram that in this situation, the energy storing cable is wired in parallel with the load.

### Example

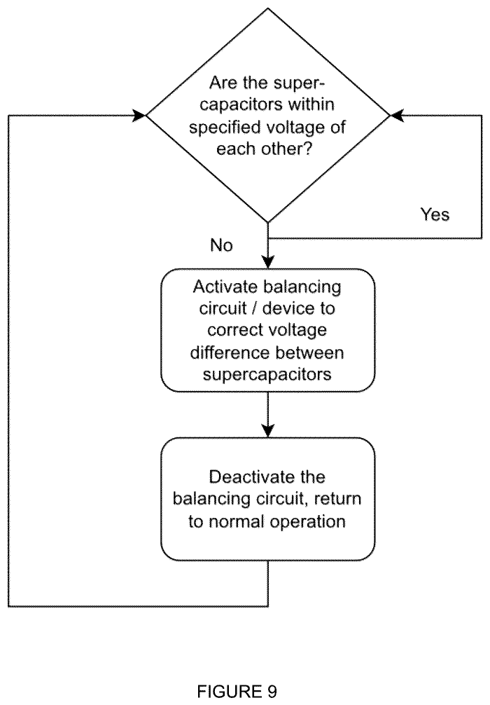

FIG. 9 shows a basic level control system logic for a supercapacitor balancing system. The microcontroller(s) or integrated circuit(s) check if the voltages of the supercapacitors in the system are within a specified tolerance of each other. The voltages of the supercapacitors, if balanced, should be the total voltage of the system divided by the number of supercapacitors configured in series. If the microcontroller(s) or integrated circuit(s) detect that a supercapacitor is outside of the specified tolerance, meaning its voltage is outside of the allowable range, it activates the balancing circuit to correct the voltage difference between the supercapacitors.

### Example

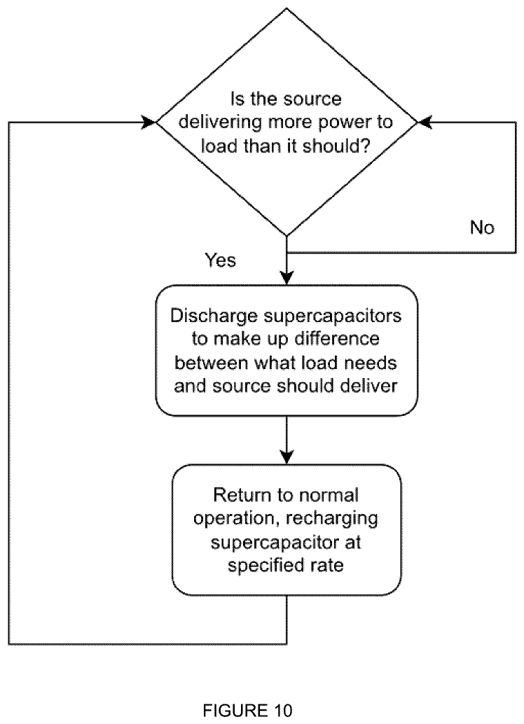

FIG. 10 shows a basic level of logic for a hybrid energy storage isolation system. The microcontroller(s) or integrated circuit(s) check if the system is experiencing a surge in current draw that exceeds what the source, such as a battery, should be delivering. If the system is experiencing a surge, the supercapacitors are discharged to make up the difference between what the load requires and what the source can deliver. After the surge, the system returns to normal operation, and recharges the supercapacitor at a specified rate.

The foregoing examples described various exemplary system-level variations and the logical operations of the balancing circuit. The following examples will describe various subsystem designs and variations, along with details of exemplary prototype circuits built in accordance with various aspects of the invention.

### Example

A breadboard prototype was used to develop and validate the supercapacitor balancing system, in this case as a small circuit board, for later configuration into a form factor suitable for placing within a cable structure. A microcontroller (Arduino Uno R3, programmed with C++) was used to read the voltages of five 2.7 V, 5 F supercapacitors (PoiLee Model CXHP2R7505R-TW) and control the single-pole double-throw switches (Songle: SRD-05 VDC-SL-C) that were pre-assembled into a relay module. Solid core copper wire (CBAZY 22 AWG Wire) was used to connect the different components to the breadboard (ELEGOO 830 Tie-Point Breadboard) and each other. The analog pins from the microcontroller were connected to the positive terminals of the supercapacitors. The negative terminal of the “last” supercapacitor in series was connected to ground. The supercapacitors were connected in series through the “normally closed” ports of the relays. The supercapacitors were connected in parallel through the “normally open” ports of the relays. The digital pins of the microcontroller are connected to the signal input ports of the relay. The battery (or battery pack) is connected in parallel with the supercapacitors through the “normally closed” port of the relay. The load is connected directly in parallel with the battery.

### Example

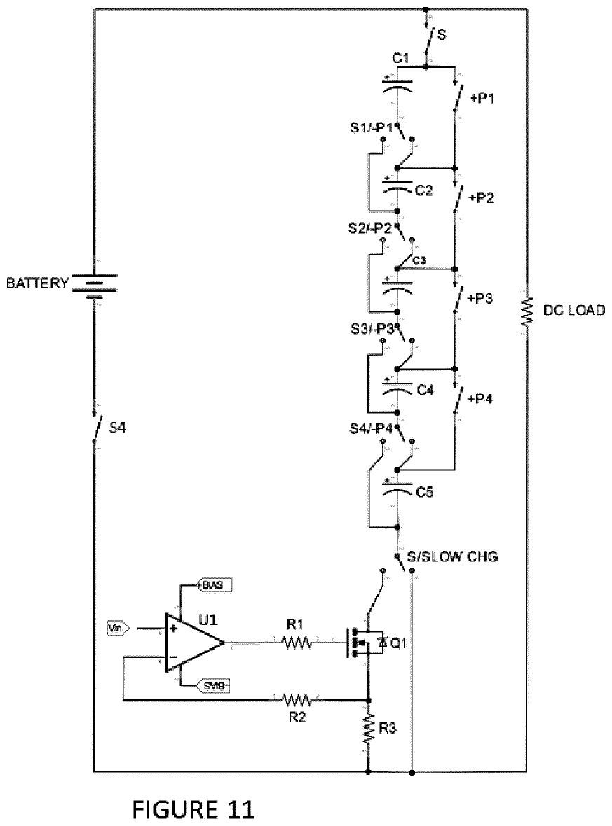

FIG. 11 shows a circuit diagram for a 12 V system with supercapacitor balancing system paired with the hybrid energy storage isolation system. The microcontroller(s) or integrated circuit(s) (not shown) control the switches in the system. They also monitor the voltage of the system and individual supercapacitors such that it will determine if the supercapacitors should be balanced or if the battery (or battery pack) needs to be disconnected from the load to protect the battery from a surge of current draw.

Switch S connects the supercapacitor in parallel with the battery and load, and is open when the supercapacitors are balancing. Switches S1/-P1 through S4/-P4 connect the supercapacitors in series through the “normally closed” port, and connect the negative terminals of the supercapacitors through the “normally open” port when in parallel. Switches +P1 through +P4 connects the positive terminals of the supercapacitors when in parallel. Switch S/SLOW CHG connects the supercapacitors directly in parallel with the battery and load through the “normally open” port, and connected in parallel with the battery and load through a variable current source through the “normally open” port after the supercapacitors have discharged during a surge. Switch S4 connects the battery in parallel with the load and is normally closed. The switch opens during a surge to protect the battery.

### Example

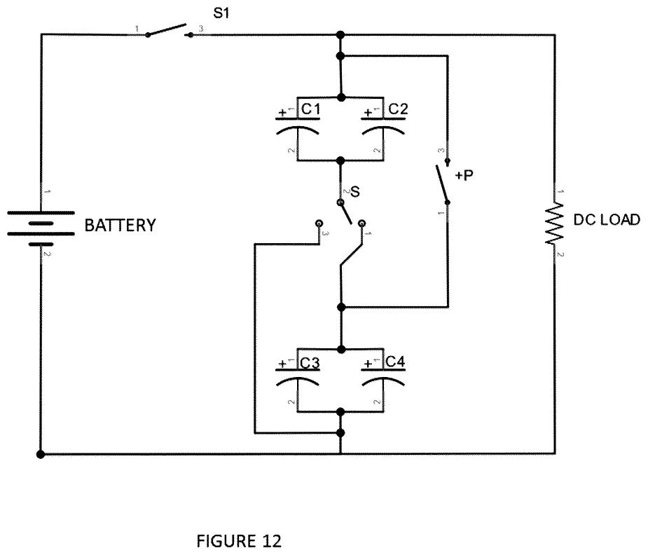

FIG. 12 illustrates a circuit diagram example of a supercapacitor balancing system where supercapacitors are placed in parallel modules to increase the capacitance of the module as deemed necessary by the application. The supercapacitor module in this example system contains two groups of two supercapacitors in parallel with a supercapacitor balancing system. Additional modules could be added in series to increase the voltage rating of the overall system. The switches that change the supercapacitor connections between series and parallel are controlled by microcontroller(s) or integrated circuit(s) (not shown).

Switch S1 connects the supercapacitors in parallel with the battery (or battery pack) and load and is normally closed. The switch opens when the supercapacitor module is in balancing mode. Switch S connects the supercapacitors in series through the “normally closed” port, and connects the negative terminals of the supercapacitors through the “normally open” port when in parallel. Switch +P connects the positive terminals of the supercapacitors when in parallel.

### Example

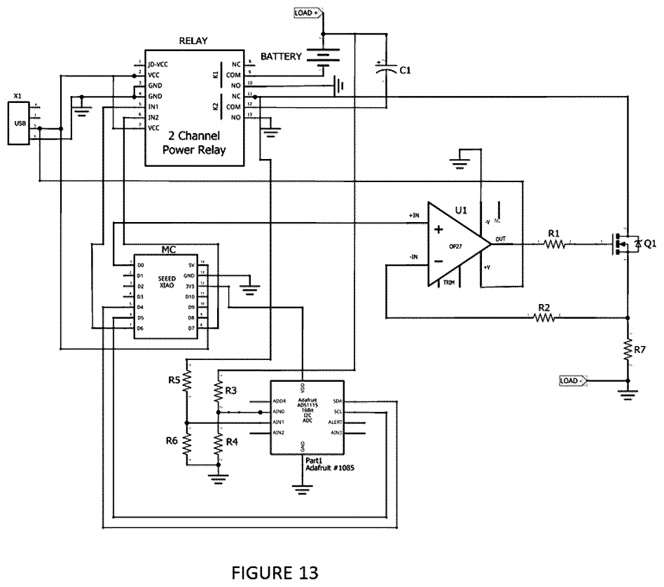

FIG. 13 shows the wiring schematic for the hybrid energy storage isolation system. This example pairs one battery with one supercapacitor. This system was prototyped to later be configured into cable-type form factor.

The microcontroller used (Seeed Studio: 102010328) monitors the system voltage using an I2C analog to digital converter (Adafruit: ADS1115), and checks if the system is experiencing a surge in current draw by comparing the current voltage to the previously read voltage. If a surge in current draw is detected, the microcontroller sends a signal to the switches (Songle: SRD-05 VDC-SL-C) to disconnect the battery (3.2 V, 1000 mAh lithium iron phosphate) from the load and let the supercapacitor module (5 V, 7.5 F) provide the power during the surge. When the supercapacitor module is reconnected in parallel with the battery, it is connected through a variable current source that includes passive components, an operational amplifier (Analog Devices: LT1006), and transistor (STMicroelectronics: STP80NF70).

### Example

Supercapacitors (e.g., PoiLee Model CXHP2R7505R-TW) could be configured within the form factor of a cable with the switches in-line in the cable. The switches may, for example, be Songle: SRD-05 VDC-SL-C. The switches would be driven by one or more microcontrollers or integrated circuits, e.g. Seeed Studio 102010328 (not shown).

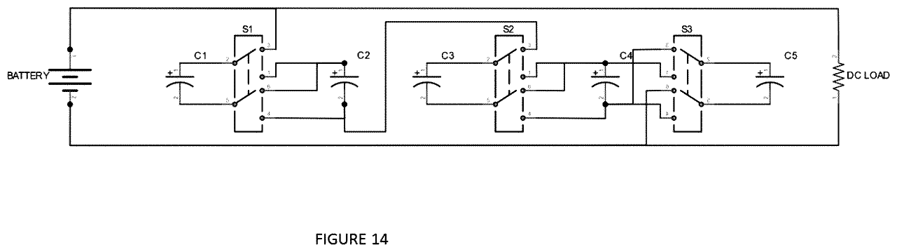

FIG. 14 shows one example with the switches in-line with the supercapacitors. The switches are of type double-pole double-throw (DPDT), which may be, for example, Takamisawa RY5 W-K. The switches are driven by one or more microcontrollers or integrated circuits, e.g. Seeed Studio: 102010328 (not shown). This configuration allows the switching to be done by three units, rather than six, making it simpler to integrate into cable form. This configuration balances two groups of supercapacitors (one group of two and one group of three) rather than one large group of five supercapacitors. The supercapacitors are normally connected in series through the “normally-closed” port in the switch. When the microcontroller(s) or integrated circuit(s) detect that the voltage of at least one of the supercapacitors is over the system voltage divided by the number of supercapacitors in series, the switches trigger to the “normally-open” port, such that the supercapacitors are connected in parallel. The supercapacitors are connected in parallel for a specified period of time to allow the supercapacitors to balance, and is then switched back to series.

### Example

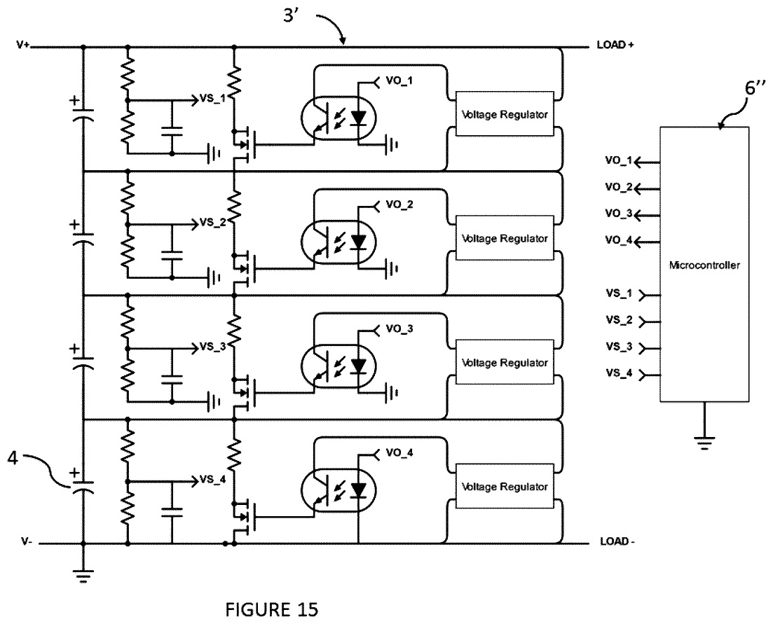

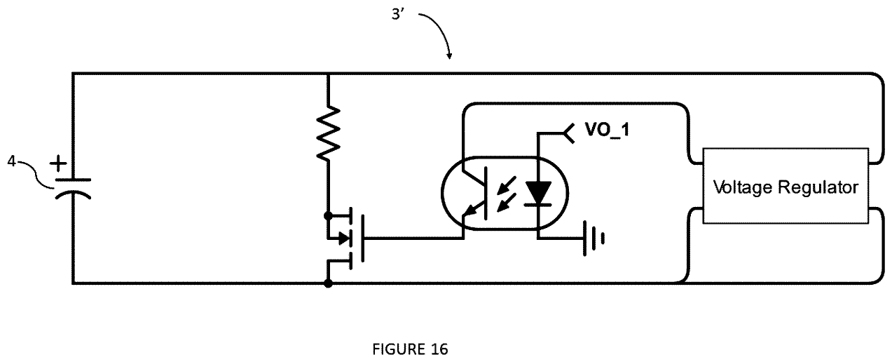

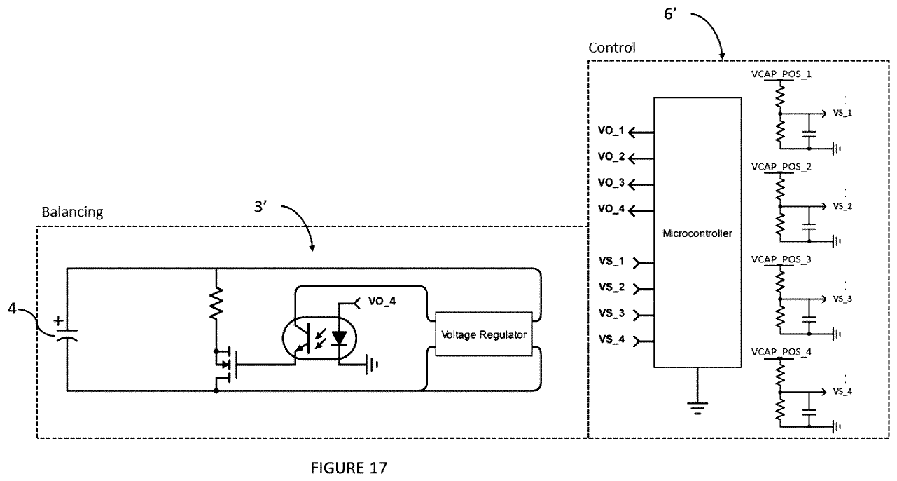

As described earlier and shown in FIGS. 2-8, Applicants contemplate that in some applications, some or all of the control electronics may be integrated directly into the cable assembly, rather than located on an external circuit board. FIGS. 15-17 provide details of one example of a circuit with four capacitors. FIG. 15 presents a schematic diagram of the full system, consisting of four balancing circuits 3′ and one control circuit containing a microcontroller 6″. FIG. 16 is a schematic of an individual balancing circuit that includes a resistor, voltage regulator, switch and an optocoupler. The balancing circuit is associated with a single supercapacitor 4. FIG. 17 shows a single balancing circuit 3′ and a control circuit 6′; these may be separate components or they may be co-located on a single circuit board. The control circuit controls the one balancing circuit shown and also controls three others, as indicated in the system drawing, FIG. 15.

### Example

An energy storing cable was made as follows. 18 AWG insulated stranded copper wire (Southwire #: 55667323) was electrically connected to the terminals of the supercapacitors (PoiLee Model CXHP2R7505R-TW) using solder seal wire connectors (Kuject SWT-21 and Kuject SWT-31). This was done on five supercapacitors. The length of the 18 AWG wire was dependent on how far away the respective supercapacitor was to be placed from the selected output end of the cable. The length of wire protruding from the end of the sheath ranged between 7 and 15 cm. Each supercapacitor was spaced roughly 10 cm from the one preceding it. Two pieces of 18 AWG insulated stranded copper wire were run through the cable which could be used as a connection point to a load. The wires were enclosed in a 1.27 cm diameter polyethylene braided sheath (Alex Tech ½ ″ Split Sleeving) that was the length of the cabling minus 14-30 cm. The cable was then enclosed in a 1.90 cm polyethylene hard-shell sheath (Alex Tech ¾ ″ Wire Loom Tubing) that was cut to the length of the cabling minus 14 to 30 cm.

This device was 77.47 cm long, 1.90 cm in diameter, had a capacitance of 1 F, and could flex to a bend radius of about 3.8 cm. The device was rated to 13.5 V.

This device was paired with circuitry that was outside of the cable. To integrate circuitry inside the cable, it is estimated that the diameter of the cable could increase to at least 3 cm in diameter. The energy storing cable would need to be longer in order to maintain the bend radius disclosed above.

### Example

Another energy storing cable was made as follows. 18 AWG insulated stranded copper wire (Southwire #: 55667323) was electrically connected to the terminals of a supercapacitor (PoiLee Model CXHP2R7505R-TW) using solder seal wire connectors (Kuject SWT-21 and Kuject SWT-31). One terminal (positive or negative) was connected to two lengths of the copper wire. This was done four times, such that two of the supercapacitors had two wires connected to the positive terminal, and the other two supercapacitors had two wires connected to the negative terminal. The supercapacitors were then paired such that one of the supercapacitors in the pair had two wires connected to the positive terminal and the other supercapacitor had two wires connected to the negative terminal. One of the two wires from the positive terminal was used to connect to the other supercapacitor's positive terminal, and one of the two wires from the negative terminal was used to connect to the other supercapacitor's negative terminal, connecting them in parallel. The supercapacitors within one parallel module were spaced roughly 12.5 cm from the other. The second wire that is connected to the positive of one supercapacitor and the second wire that is connected to the negative of the other supercapacitor were run the length of the cable to act as access points to the set of parallel supercapacitors. Two pieces of 18 AWG insulated stranded copper wire were run through the cable which could be used as a connection point to a load. The two pairs of parallel supercapacitors were spaced roughly 14.5 cm from each other. The wires were enclosed in a 1.27 cm diameter polyethylene braided sheath (Alex Tech ½ ″ Split Sleeving) that was the length of the cabling minus 14-30 cm. The cable was then enclosed in a 1.27 cm polyethylene hard-shell sheath (Alex Tech ½ ″ Wire Loom Tubing) that was cut to the length of the cabling minus 14-30 cm. The length of wire protruding from the end of the sheath ranged between 7 and 15 cm.

This device was 63.5 cm long, 1.27 cm in diameter, had a capacitance of 4.15 F, and could flex to a bend radius of about 2.54 cm. The device was rated to 5 V.

This device was paired with circuitry that was outside of the cable. To integrate circuitry inside the cable, it is estimated that the diameter of the cable could increase to at least 3 cm in diameter. The energy storing cable would need to be longer in order to maintain the bend radius disclosed above.

The two preceding examples show that in general, the overall dimensions of the energy storing cable are dependent on the capacity needed for a particular application, because the capacity will dictate the number and size of the capacitors arranged in the cable. The skilled artisan may therefore construct a cable having sufficient capacity for any particular application. The skilled artisan will further appreciate that a cable that can be flexed around a radius of curvature as small as twice its own diameter is effectively flexible enough to accommodate many installation arrangements and will therefore open up many layouts and design possibilities that cannot be accommodated by the traditional capacitor array on a rigid circuit board. At the same time, in other applications, a cable that is only capable of bending around a larger radius of curvature, say, five times its diameter, may be considered sufficiently flexible to accommodate varying installation conditions in the field. Applicants further contemplate that the control circuits may in some applications, especially lower power situations, be built on flex circuits rather than on rigid circuit boards, to afford greater flexibility to the cable. Furthermore, the cable may be configured with a cross section of any desired shape, and it will be appreciated that a cable with a rectangular or ribbon like cross section will be more flexible in the thin dimension than a round cable of the same cross sectional area.

The skilled artisan will appreciate that the cable may have structural components incorporated to increase cable robustness, structural integrity, and meet application requirements. These structural components may include but are not limited to: strong wire or bungee cord running lengthwise to prevent tensile forces on the internal wiring, protective casing around fragile internal components, protective casing around components to meet NEMA or IP standards, additional layers of outer sheaths, a skeletal-like outer frame.

The skilled artisan will appreciate that many variations of the invention may be configured for particular purposes including: input wires on one end of the cable and the output wires on the other end of the cable, both the input wire and the output wire on the same end of the cable, the input wire and the output wires being the same pair of wires.

The skilled artisan will appreciate that many variations of the invention may be configured for particular purposes including: an energy storing cable with circuitry located outside of the cable, an energy storing cable with supercapacitor balancing integrated into the cable, an energy storing cable with a hybrid energy storage isolation system integrated into the cable, an energy storing cable with a supercapacitor balancing and hybrid energy storage isolation system integrated into the cable.

Further details and the results of experimental testing of the systems

### Example

Table 1 displays the values obtained from two experimental prototypes and testing.

TABLE 1
Prototype tests

| | | | | Internal | Cable | Cable | No. of |
|---|---|---|---|---|---|---|---|
| | Rating, | Capₜₕₑₒᵣ. | Cap_{obs,} | resistance, | Diam, | length, | super- |
| Sample | V | F | F | Ω | mm | mm | caps |
| 1 | 13.5 | 1 | 1 | 0.9 | 19.05 | 774.7 | 5 |
| 2 | 5.4 | 5 | 4.15 | 0.09 | 12.7 | 635 | 4 |

Cable sample 2 underwent galvanostatic charge-discharge (GCD) cycle testing. The cable was charged from 0.1 V to 5 Vat 1000 mA and discharged from 5 V to 0.1 V at 1000 mA for 5 cycles. The average calculated capacitance was 4.15 F.

### Further Examples and Variations of the Invention

Energy Storing Cable

In some examples, the energy storing cable includes supercapacitors that could be symmetric, where the material for both electrodes are similar, or asymmetric, where the material for the electrodes differ from each other. In some embodiments, the supercapacitors could be of such types as electrostatic double-layer, hybrid supercapacitor, electrochemical pseudocapacitor, curved graphene, lithium-ion capacitor, and polyacene capacitor. The supercapacitors could be of flat, radial, flexible, or wire shaped form factor. The supercapacitors could have termination types that are axial, connector, flexible, lug, pin, radial, SMD/SMT (surface mount), screw, snap-in, stud thread, or through-hole.

In some examples, the energy storing cable includes capacitors that could be of types including but not limited to: aluminum electrolytic, ceramic, feed through, film, mica, multilayer ceramic (MLCC), niobium oxide, polymer, thin-film, and tantalum.

In some examples, small disk-shaped wiring guides or harnesses may optionally be placed between the individual capacitors to securely position the internal wiring as it travels the length of the cable. Such wire guides may be made from any material that can be molded, shaped, or cut to a specified shape. Other optional components include methods to splice and connect various wires together, which can be helpful in connecting balancing circuits to supercapacitor modules.

The cabling that is attached to the terminals of the supercapacitor may be sized accordingly with the current rating of the application. The length of the cabling may be sized accordingly with respect to the application. The conductive portion of the cabling could be any conductive metal including but not limited to: copper, nickel, gold, chromium, titanium, aluminum, and alloys and composites thereof. The conduction portion of the cabling can be of either stranded or solid configuration. The outer, insulative portion could be any insulative material including but not limited to any variation of thermoplastics and thermosets.

The supercapacitor may be attached to a PCB, and the cabling may be attached to the PCB rather than directly to the terminals. The PCB does not necessarily need a function other than as a connective device.

The terminals of the supercapacitor may be bent (if applicable) in some embodiments.

The elongated sheath surrounding the components of the cable may be sized accordingly and could be of any flexible insulative material including but not limited to: polyethylene terephthalate (PET), neoprene, nylon, polyester, polyphenylene sulfide monofilament (PPS), Nomex, polyolefin, fluoropolymers, PVC, and other thermoplastics. The sheath surrounding the components of the cable could be of conduit types including but not limited to: braided sleeve, split, zipper, spiral, loom, Velcro, and hook and loop.

In some examples, there may be more than one outer, one layer, or no layers.

In some examples, the supercapacitor terminals could be connected to the cabling using connection means including but not limited to: solder, solder seal connectors, twist cap connectors, push-in connectors, lever connectors, crimp-on connectors, lugs, ring terminals, and screw-on terminals.

In some examples, the termination of the cable could be of the style including but not limited to: board-to-board, wire-to-board, wire-to-wire, FFC, FPC.

In some examples, the supercapacitors can be connected to each other directly or through a switch.

Supercapacitor Management System

In some examples, the supercapacitor management system could be placed outside of the energy storing cable, as well as placed in-line in the energy storing cable.

In some examples, the switches used in the system could be relays of types including but not limited to: normally open (NO) or normally closed (NC) single-pole single-throw (SPST), single-pole double-throw (SPDT), NO or NC double-pole single-throw (DPST), and double-pole double-throw (DPDT). The switches used in the system can also be built using switches, relays, diodes, transistors, and optocouplers among other parts.

Hybrid Energy Storage Isolation System

In some examples, the hybrid energy storage isolation system could be paired with the aforementioned supercapacitor management system.

In some examples, the hybrid energy storage isolation system could be placed outside of the energy storing cable, as well as placed in-line in the energy storing cable.

In some examples, the switches used in the system could be relays of types including but not limited to: normally open (NO) or normally closed (NC) single-pole single-throw (SPST), single-pole double-throw (SPDT), NO or NC double-pole single-throw (DPST), and double-pole double-throw (DPDT). The switches used in the system can also be built using various types of switches, relays, diodes, transistors, and optocouplers, among other parts.

It will be appreciated that certain advanced energy storage devices have some capacitor-like properties and some battery-like properties (e.g., electrochemical pseudocapacitors). Applicant therefore contemplates that the invention may comprise a flexible chain of energy storage modules as described herein, but the energy storing component(s) in a module may be a capacitor, a battery, or a battery pack, which might include further control and balancing electronics. The exemplary balancing circuits described herein may be directly applicable to energy storage modules using batteries instead of capacitors, or they may be modified to a greater or lesser degree depending on the particular attributes of the storage devices selected. Balancing circuits may not be required in some cases.

We claim:

1. An energy storing cable comprising:
a flexible elongated sheath;
input lines to receive input power from a source;
output lines to provide output power to a load;
a microcontroller; and,
a plurality of individual energy storage modules contained within the sheath, each module comprising:
at least one capacitor, and,
at least one switching device operatively connected to the at least one capacitor and to the microcontroller so that the microcontroller may balance the charge states of each of the individual energy storing modules and manage the flow of power between the source, the energy storage modules, and the load; and,
wherein the individual energy storing modules are sufficiently spaced apart from one another along the length of the sheath so that the energy storing cable has a useful degree of flexibility.

2. The energy storing cable of claim 1 wherein the input power is selected from the group consisting of: AC power and DC power.

3. The energy storing cable of claim 1 wherein the output power is selected from the group consisting of: AC power and DC power.

4. The energy storing cable of claim 1 wherein the microcontroller comprises a circuit disposed within the cable sheath.

5. The energy storing cable of claim 1 wherein the switching device comprises a balancing circuit.

6. The energy storing cable of claim 5 wherein the operative connection between the switching device and the microcontroller comprises a signal bus disposed within the cable sheath.

7. The energy storing cable of claim 5 wherein the operative connection between the switching device and the microcontroller comprises a wireless communication link.

8. The energy storing cable of claim 1 further comprising a device selected from the group consisting of: DC/DC bidirectional converters, source control circuits, DC/DC converters, AC/DC converters, DC/AC converters, and AC/DC bidirectional converters.

9. The energy storing cable of claim 8 wherein the selected device is disposed within the cable sheath.

10. The energy storing cable of claim 1 wherein the cable is sufficiently flexible that it can be bent around a radius of curvature of five times the cable diameter.

11. The energy storing cable of claim 10 wherein the cable is sufficiently flexible that it can be bent around a radius of curvature of two times the cable diameter.

12. The energy storing cable of claim 1 wherein the power source is selected from the group consisting of: energy storage devices, renewable energy sources, non-renewable energy sources, generators, and the utility grid.

13. The energy storing cable of claim 1 wherein the load is selected from the group consisting of: the utility grid, electronic devices, electric vehicles and other e-mobility platforms, charging stations, renewable energy systems, telecom systems, and microgrids.

14. The energy storing cable of claim 1 wherein each of the energy storing modules comprises a capacitor device selected from the group consisting of: symmetric capacitors, asymmetric capacitors, electrostatic double-layer capacitors, hybrid supercapacitors, electrochemical pseudocapacitors, curved graphene capacitors, lithium-ion capacitors, polyacene capacitors, aluminum electrolytic capacitors, ceramic capacitors, feed through capacitors, film capacitors, mica capacitors, multilayer ceramic capacitors (MLCC), niobium oxide capacitors, polymer capacitors, thin-film capacitors, and tantalum capacitors.
